(19) United States
(12) Patent Application Publication
(10) Pub. No.: US 2008/0236919 A1
(43) Pub. Date: Oct. 2, 2008

(54) Electric grid for an electric machine

(75) Inventor: Trevor N. Iund, Peoria, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc.

(21) Appl. No.: 11/729,478

(22) Filed: Mar. 29, 2007

(51) Int. Cl. B60K 1/02

(52) U.S. Cl. 180/69.6; 477/4; 60/272

(57) ABSTRACT

An electric machine including an engine, generator, and motor. The electric grid is positioned between an input passage and output passage of an exhaust system of the engine. While in retard mode, excess electric power is dumped to the electric grid. Continuous airflow from the engine through the exhaust system removes the energy, in the form of heat, away from the electric grid.

### TECHNICAL FIELD

This invention relates to electric drive systems for propelled machines, and more particularly to electric grids for machines having an electric drive.

### BACKGROUND

Conventional propelled machines generally include an internal combustion engine that is mechanically coupled through a transmission assembly and drive train to driven wheels or sprockets of the machine. In contrast, propelled machines having electric drive systems including an internal combustion engine that is mechanically coupled to a generator, which creates electrical power. A motor that is mechanically coupled to drive the wheels of the propelled machine then consumes the power from the generator. Accordingly, the generator and motor of the electric drive systems replace the mechanical transmission and drive train of conventional internal combustion engine driven machines. This may result in a propelled machine with superior drive train efficiency and improved propulsion performance, which correlates to a machine having greater fuel economy and reduced emissions.

To retard the machine, the motor acts as a generator and the generator acts as a motor to drive the engine. In many situations, however, excess energy must be dissipated through a retarding grid. On machines where space is limited, proper placement of the retarding grid is difficult.

European Patent 0 603 907, filed Dec. 23, 1992, entitled Motor vehicle, particularly city-bus, with a diesel engine/generator unit, teaches an electric drive bus with a particle filter enclosed within an exhaust duct of the diesel engine. Electric leads from the generator, which provides power to the motor, provide energy to heating elements within the particle filter. The heating elements draw power from the generator at predetermined times to provide heat to regenerate the particle filter.

The present disclosure is directed to overcoming some or all of the shortcomings in the prior art.

### SUMMARY OF THE INVENTION

According to one aspect, an exhaust system is provided. The exhaust system includes an inlet passage adapted to receive a flow of exhaust from an engine, an outlet passage adapted to expel the exhaust, and an electric grid, adapted to receive excess power during a retarding moment, positioned between the inlet passage and the outlet passage, in direct communication with the exhaust.

According to another aspect, an electric machine is provided. The electric machine includes an engine having an exhaust system, a generator connected to the engine, and an electric grid electrically connected to the generator. The electric retarding grid is positioned substantially within the exhaust system in direct communication with air traveling through the exhaust system. The power electronics direct excess energy during a retarding moment to the electric retarding grid.

According to yet another aspect, a method of cooling an electric grid of an electric machine having an engine, a generator, and an exhaust system, is provided. The method includes the steps of determining when a retarding condition is present, causing the generator to motor the engine, dumping excess electrical power from the generator to the electric grid within the exhaust system, and passing air from the engine through the exhaust system into direct communication with the electric grid.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate exemplary embodiments of the invention and, together with the description, serve to explain the principles of the invention. In the drawings,

FIG. 1 illustrates an electric machine according to one embodiment of the present disclosure; and

FIG. 2 illustrates a schematic drawing of an electric retarding system according to another embodiment of the present disclosure.

### DETAILED DESCRIPTION

Reference will now be made in detail to embodiments or features of the invention. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

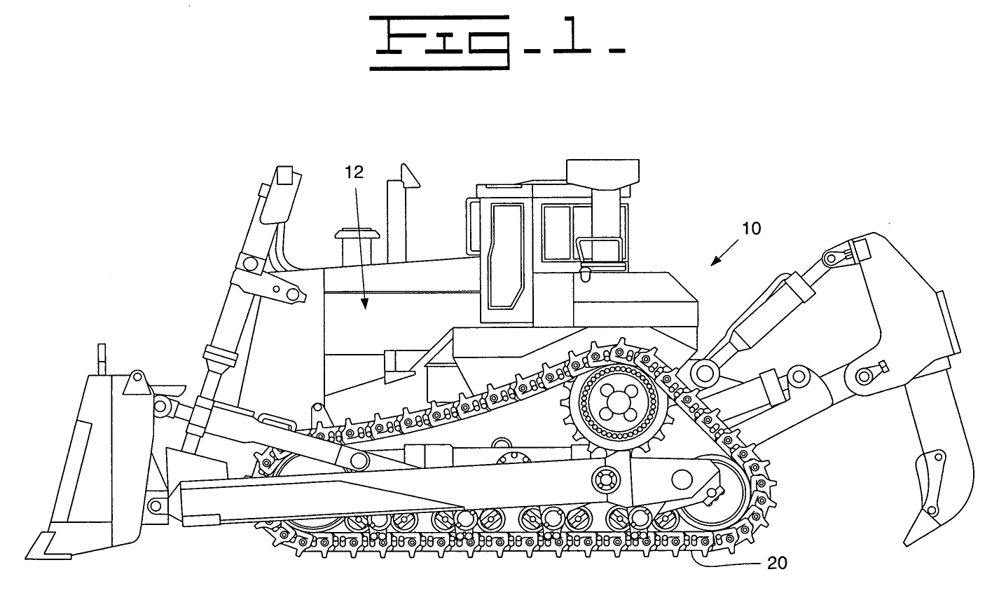

FIG. 1 provides a diagrammatic perspective view of a work machine 10 according to an exemplary disclosed embodiment. While work machine 10 is illustrated as a mining vehicle, work machine 10 may also be any type of work machine that includes one or more electric motors. For example, work machine 10 may include on-highway vehicles, automobiles, tractors, wheel loaders, excavators, skid steers, and other types of machinery.

The work machine 10 includes a power source 12 configured to provide a power output for powering various operations of the work machine 10. The power source 12 may be an internal combustion engine that operates using diesel fuel, gasoline, natural gas, or other type of fuel.

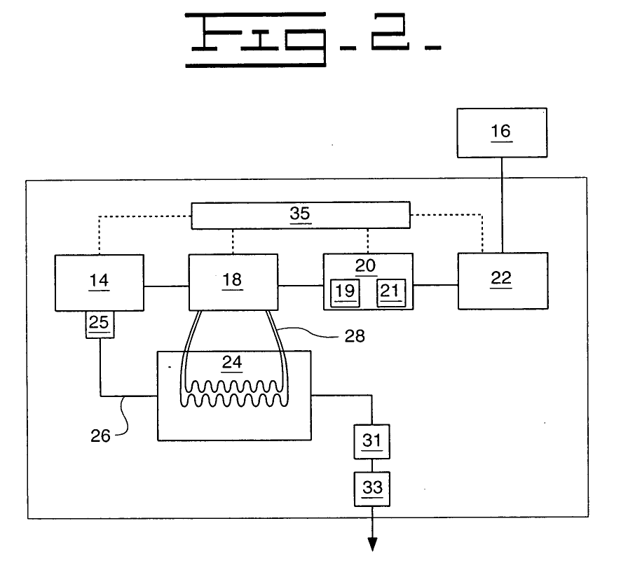

Referring to FIG. 2, the electric drive 12 includes a generator 18 connected to the engine 14, power electronics 20 connected to the generator 18, and at least one motor 22 connected to the power electronics 20.

Electrical energy produced by the generator 18 may be used to drive the electric motor 22. For example, the generator 18 may be configured to provide a three-phase output of a desired voltage level (e.g., 480 V or any other suitable level) and supply this output to the power electronics 20. The power electronics 20 includes a generator power converter 19 and a motor power converter 21. The generator power converter 19 may convert the three-phase voltage to a DC voltage of another desired level (e.g., 615 V or any other suitable level). The motor power converter 21 may be configured to receive the voltage supplied by the generator power converter 19 and to provide a variable voltage, three-phase, AC voltage to drive the motor 22.

The generator 18 electrically communicates with an electric grid 24, positioned at any location within an exhaust system 26 of the engine 14. Specifically, the electric grid 24 is positioned downstream from the engine exhaust ports 27, before or after a particulate filter 29, or before or after other devices, such as, for example, a catalytic converter 31 or muffler 33.

The electric motor 22 may be mechanically coupled to a final drive assembly 30, a transmission (not shown), a differential (not shown) or other torque-transmitting device to provide a driving force to the driven elements 16 of the machine 10.

A control unit 35 electrically communicates with the engine 14, the generator 18, the power electronics 20, and the electric motor 22. The control unit 35 continuously monitors conditions of the machine 10 to send and receive speed and torque commands, desired speed commands, actual speed signals, etc. When the actual speed exceeds a desired speed the control unit 35 commands the machine 10 into a retarding mode.

While in retarding mode, the power electronics 22 provide reverse power capability to enable the generator 18 to operate as an electric motor for powering the internal combustion engine 14 while operating in retard mode, or during a retarding moment. Excess electricity is sent to the electric grid 24.

The electric grid 24 converts the excess electricity into heat by, for example, controlling the current across a heat-emitting element 28, such as a power resistor, or a plurality of power resistors arranged in series and/or parallel form. In one embodiment, the power resistor(s) 28 is/are configured to receive between 50 and 500 kilowatts of excess energy during a retarding moment. It is noted that the electric grid 24 may be configured to receive more energy under transient conditions where the excess energy is momentarily “pulsed” to the electric grid 24, rather than continuously applied.

### INDUSTRIAL APPLICABILITY

During propulsion of the machine 10 the internal combustion engine 14 combusts fuel to drive the generator 18. The generator 18, in turn, produces electrical power that is provided to the power electronics 16 and to the electric motor 22 to drive the driven elements 16.

While in retard mode, the driven elements 16 drive the motor 22, acting as a generator, to create electrical power. The retarding condition, or retarding moment, is detected when the control unit 35 detects that the desired speed is less than the actual speed, or when the machine is attempting to move in a direction faster than the desired speed. The electrical power travels through the power electronics 20 to drive the generator 18, now acting as a motor. The generator/motor power electronics allow the motor 22 to drive the engine 14, relying on friction and parasitic losses to create loads on the generator/motor to slow the machine. Excess electrical power, or energy, is dissipated to the electric grid 24 located within the exhaust system 26. The control unit may be configured to predetermine a maximum amount of retarding available from the engine, or other parasitic devices, such as a pump, air conditioning system, etc. It is understood that the terms “energy” and “power” are referred to herein interchangeably.

The power electronics of the generator 18 control the amount of energy used to retard the engine 14. When the engine 14 reaches a maximum retarding capability, the excess energy passes to the electric grid 24 and converts to heat. Exhaust gases exiting the engine 14 through the exhaust ports, and traveling through the exhaust system 26, provides relatively cool gas over the electric grid 24 to remove the heat therefrom.

It will be apparent to those skilled in the art that various modifications and variations can be made in the disclosed system and method without departing from the scope or spirit of the embodiments of the invention. Other embodiments of the invention will be apparent to those skilled in the art from consideration of the specification and practice of the embodiments of the invention disclosed herein. It is intended that the specification and examples be considered as exemplary only.

What is claimed is:

1. An exhaust system, comprising:
an inlet passage adapted to receive a flow of exhaust from an engine;
an outlet passage adapted to expel the exhaust; and
an electric grid, adapted to receive excess power during a retarding moment, positioned between the inlet passage and the outlet passage, in direct communication with the exhaust.

2. The exhaust system according to claim 1, further comprising a particulate filter wherein the electric grid is positioned downstream of the particulate filter.

3. The exhaust system according to claim 1, further comprising a muffler, wherein the electric grid is positioned upstream of the muffler.

4. The exhaust system according to claim 3, further comprising a catalytic converter positioned upstream of the muffler and wherein the electric grid is positioned upstream of the catalytic converter.

5. The exhaust system according to claim 1, wherein the electric grid comprises a heat-emitting element adapted to convert electric energy to heat.

6. The exhaust system according to claim 5, wherein the heat-emitting element is a resistor.

7. An electric machine, comprising:
an engine having an exhaust system;
a generator connected to the engine;
power electronics electrically connected to the generator; and
an electric retarding grid electrically connected to the generator, and positioned substantially within the exhaust system in direct communication with air traveling through the exhaust system, wherein the power electronics direct excess energy during a retarding moment to the electric retarding grid.

8. The electric machine according to claim 7, further comprising a motor electrically connected to the generator and driven elements.

9. The electric machine according to claim 8, further comprising power electronics connected between the motor and the generator, the power electronics adapted to selectively control electric energy from the generator to the motor and from the motor to the generator.

10. The electric machine according to claim 8, wherein the generator and the motor both include reverse power electronics to allow the motor to act as a generator and the generator to act as a motor, while in retard mode.

11. The electric machine according to claim 10, wherein power electronics of the generator direct excess power from the generator, while in retard mode, to the electric grid, which is converted to heat.

12. The electric machine according to claim 7, further comprising a particulate filter wherein the electric grid is positioned downstream of the particulate filter.

13. The electric machine according to claim 7, further comprising a muffler, wherein the electric grid is positioned upstream of the muffler.

14. The electric machine according to claim 13, further comprising a catalytic converter positioned upstream of the muffler and wherein the electric grid is positioned upstream of the catalytic converter.

15. The electric machine according to claim 7, wherein the electric grid comprises a heat-emitting element adapted to convert electric energy to heat.

16. The electric machine according to claim 16, wherein the heat-emitting element is a resistor.

17. A method of cooling an electric grid of an electric machine having an engine, a generator, and an exhaust system, the method comprising the steps of:
determining when a retarding condition is present;
causing the generator to motor the engine;
dumping excess electrical power from the generator to the electric grid within the exhaust system; and
passing air from the engine through the exhaust system into direct communication with the electric grid.

18. The method of claim 17, further comprising the step of converting the excess electrical power to heat within the electric grid and transferring the heat from the electric grid to the air passing over the electric grid.
